(19) United States
(12) Patent Application Publication
(10) Pub. No.: US 2010/0012585 A1
(43) Pub. Date: Jan. 21, 2010

(54) MEMBRANE FILTRATION PROCESS AND DESIGN

(76) Inventors: Fufang Zha, New South Wales (AU); Dean Osman Cameron, Queensland (AU); Alex Nygard, New South Wales (AU); Warren Thomas Johnson, New South Wales (AU)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/527,349

(22) PCT Filed: Feb. 15, 2008
(86) PCT No.: PCT/AU08/00204

§ 371 Date: Aug. 14, 2009

(30) Foreign Application Priority Data
Feb. 16, 2007 (AU) 2007900764
Nov. 22, 2007 (AU) 2007906397

(51) Int. Cl. B01D 65/06; B01D 69/08

(52) U.S. Cl. 210/636; 210/408; 210/137; 210/86; 210/104

(57) ABSTRACT

A membrane filtration system (5) including: a feed containing vessel (7); a membrane module (6) including one or more hollow permeable membranes (8) for filtering feed liquid, located in the feed containing vessel (7); means for applying a pressure differential across walls of the membranes (8) to induce filtration therethrough; a feed liquid reservoir (9) in fluid communication with the membrane module (6) to supply feed liquid thereto; a source of feed liquid (12); a source of gas (10) and means (11) for selectively producing a flow of gas from the gas source (10) and feed liquid from the feed liquid source (12) through the membrane module (6) and into the feed liquid reservoir (9). The flow of gas producing gas bubbles within the feed liquid to clean the membranes (8).

### TECHNICAL FIELD

The present invention relates to a filtration system employing permeable hollow membranes and more particularly to a simplified design of such systems.

### BACKGROUND OF THE INVENTION

A membrane filtration process normally involves filtration and cleaning of the membranes to maintain efficiency of the filtration. Filtration is achieved by applying a pressure differential across the membrane walls either through pumping or by gravity resulting in the flow of filtrate through the membrane pores with the removed solids being retained on the feed side of the membrane wall or within the pores. Regular cleaning is achieved through liquid/gas backwash of the membranes and/or gas/liquid scouring of the membrane surfaces. The whole process requires a large amount of ancilliary pumps, blowers, compressors and many valves. For small scale applications, such as home, rural area, disaster relief and domestic wastewater applications, there is a need to develop very simple membrane filtration systems that require minimum mechanical equipment and valves, and minimum maintenance, while retaining good cleaning efficiency to allow the membrane system to be operational for sufficient time without special attention or membrane replacement.

### DISCLOSURE OF THE INVENTION

It is an object of the present invention to overcome or ameliorate at least one of the disadvantages of the prior art, or to provide a useful alternative.

According to one aspect, the present invention provides a membrane filtration system including:

a feed containing vessel;

a membrane module including one or more hollow permeable membranes for filtering feed liquid, located in said feed containing vessel;

means for applying a pressure differential across walls of said membrane to induce filtration therethrough;

a feed liquid reservoir in fluid communication with said membrane module to supply feed liquid thereto;

a source of feed liquid;

a source of gas;

means for selectively producing a flow of gas from said gas source and feed liquid from said feed liquid source through said membrane module and into said feed liquid reservoir,

said flow of gas producing gas bubbles within said feed liquid to clean said membranes.

Preferably, the means for producing a flow of gas and feed liquid includes a pump. For preference, the gas source comprises a gas-containing reservoir. Preferably, the pump is provided between the source of feed liquid and the gas-containing reservoir and in fluid communication therewith. For further preference, the gas-containing reservoir is fluidly connected to said feed-containing vessel. Preferably, a non-return valve is provided between the gas-containing reservoir and the feed containing vessel to allow fluid flow from the gas-containing reservoir to the feed containing vessel. For preference, the pump is selectively operable in dependence on the level of feed liquid in the source of feed liquid. Preferably, said source of feed liquid comprises a feed liquid supply tank and a first and a second level detection means are provided in said tank, said second level detection means detecting a second level of feed liquid in said tank higher than a first level detected by said first level detection means. Alternatively, the level detection means can be integrated in the pump (certain submersible pumps have built-in level switches.). The pump is responsive to detection of said second level of feed liquid to operate and to detection of said first level of feed liquid to cease operation.

An alternative to level control is timer control, where a timer is activated by a level switch and can be adjusted to provide more precise control over the oxygenation of the feed liquid/membrane interface, and in particular can be used to cycle between oxic and anoxic biofilm states to produce controlled denitrification in a high BOD₅ film, or enhanced colour or odour removal under aerobic bioreactor conditions. In such an arrangement a timer means is operable to activate said pump for a predetermined period and said source of feed liquid comprises a feed liquid supply tank and a level detection means is provided in said tank, said level detection means detecting a predetermined level of feed liquid in said tank and said timer means is responsive to detection of said predetermined level of feed liquid to activate said pump for said predetermined period.

Preferably, the means for providing a pressure differential across the membrane walls includes locating the feed liquid reservoir above the level of said membrane module such that a static head pressure is applied to said membranes inducing filtration therethrough, however, in another embodiment, the pressure differential across the membrane walls may be produced or augmented by a pump applying pressure to the feed side of the membranes or suction to the filtrate side of the membranes. Preferably, the pump is the same pump used to produce a flow of gas and feed liquid. In a further embodiment, a pressure vessel with an air reservoir above the liquid is used to provide a higher driving head pressure.

According to another aspect, the present invention provides a method of filtering filtrate from a multi-component feed liquid including the steps of:

providing a source of said feed liquid;

providing a source of gas;

flowing gas from said source of gas through a membrane filtration module, including one or more hollow permeable membranes, into a feed liquid reservoir located above said membrane filtration module to produce gas bubbles within and/or around the membranes to remove accumulated solids therefrom;

flowing feed liquid from the source of feed liquid past the membranes within said module to sweep said removed solid from the membrane filtration module; and

producing filtration of feed liquid through a wall of said membranes by application of static or driven head pressure from feed liquid held in said feed liquid reservoir.

For preference, the flow of feed liquid and gas is selectively controlled in response to a level of feed liquid at the source of feed liquid.

### BRIEF DESCRIPTION OF DRAWINGS

Preferred embodiments of the invention will now be described, by way of example only, with reference to the accompanying drawings in which:

FIG. 1 shows a schematic diagram of one embodiment of the invention;

FIG. 2 shows a schematic diagram of a second embodiment of the invention;

FIG. 3 shows a schematic diagram of a third embodiment of the invention; and

FIG. 4 shows a schematic diagram of a fourth embodiment of the invention.

### DESCRIPTION OF PREFERRED EMBODIMENTS

Referring to the drawings, the basic configuration of the preferred embodiments includes three components:
1. A membrane unit 5 containing one or more filtration membrane modules 6 located within a feed vessel 7. The modules 6 typically contain one or more hollow permeable membranes 8. The membranes may be fibres, tubes, sheets or the like.
2. A header tank 9 which stores the feed liquid for supply under gravity to the membranes for filtration.
3. A gas reservoir or chamber 10 which preserves an amount of gas, typically air, that is required for cleaning the membranes.

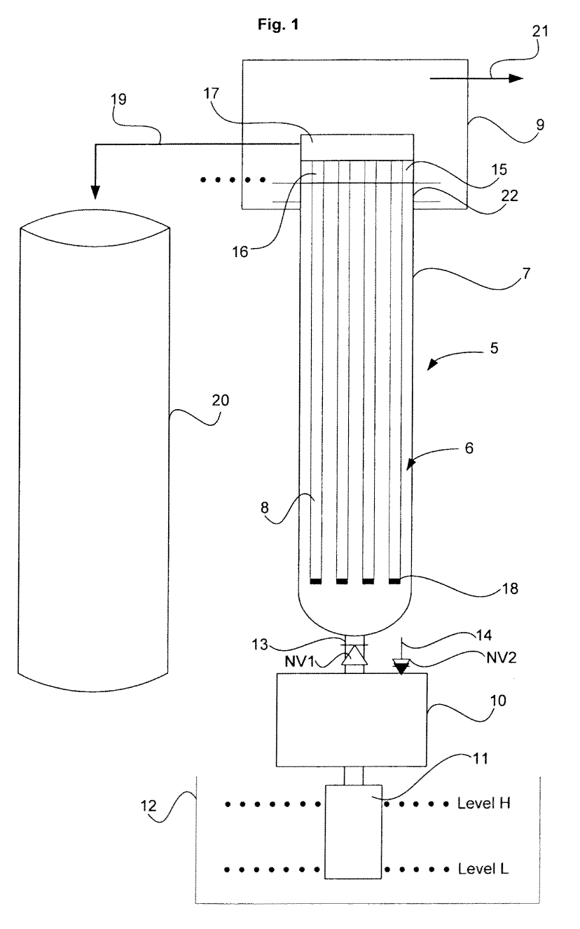

FIG. 1 shows one embodiment of the invention. This embodiment includes the above three components. A pump 11 is coupled to the gas chamber 10 and used to deliver feed liquid, typically water, to the membrane unit 5 to be filtered. The pump's operation is determined by two level switches (not shown) operable at feed liquid levels H and L within the feed reservoir 12. It will be appreciated the pump may also be a vacuum pump coupled to the header tank 9 to draw feed liquid through the system.

A feed inlet line 13 controlled by a non-return valve NV1 is connected between the gas chamber 10 and the membrane unit 5. A further non-return or gas induction valve NV2 controls a gas inlet line 14 connected to the gas chamber 10.

In this embodiment and the others described later, the membranes 8 are arranged in a vertical configuration and potted in an upper header 15 with their upper ends 16 in open fluid communication with a filtrate collection chamber 17 and their lower free ends 18 sealed, however, it will be appreciated that any appropriate known membrane module configuration may be used, including those with membranes extending between upper and lower headers and non-vertically mounted membranes.

The filtrate collection chamber 17 is coupled via a filtrate line 19 to a filtrate storage tank 20. The header tank 9 is also preferably provided with an overflow line 21 positioned at level so as to provide a head of feed liquid to the membrane unit 5. A module vent port 22 is provided below or near the upper header 15 to allow flow of liquid and gas from the module 6 into the header tank 9.

The operation of this embodiment will now be described. Once the feed water level reaches a predetermined start-up level H in the feed reservoir 12, the pump 11 starts pumping feed water. The pump stops when the lower level switch is operated when the feed liquid level falls below a predetermined lower level in the feed reservoir 12 indicated by level L.

When the pumped feed water enters the gas chamber 10 it compresses the gas and pushes the gas through the non-return valve, NV1, into the membrane unit 5, scouring the membranes 8 and then being released via the module vent port 22 through the header tank 9. The compressed gas within the gas chamber 10 closes the non-return valve NV2 so gas within the chamber 10 cannot be released to atmosphere.

As the pump 11 continues operation, it delivers feed water to sweep the membrane module 6 of solids dislodged from the membranes by the gas scouring and finally flows feed water through the module vent port 22 into the header tank 9. During the pump-on cycle there is filtration of feed liquid through the membrane walls depending on the dynamic and static head in the membrane housing and header tank 9.

The pump 11 operation stops when the feed level in the reservoir tank (not shown) drops to a level L. After the feed pump 11 stops, the feed water in the header tank 9 and inside the membrane unit 7 cannot flow back due to the operation of the non-return valve NV1. The static head difference between the feed level in the header tank 9 and the filtrate line 19 produces a pressure differential across the membrane walls to drive the membrane filtration process until such a difference reaches zero. Meanwhile, the feed water in the gas chamber 10 back-flows to the feed reserve tank after the pump 11 stops and gas, typically air, flows through gas inlet line 14 into the gas chamber 10 through the NV2. This serves to refill the gas chamber in readiness for the next scouring cycle.

To avoid the accumulation of suspended solids in the header tank 9, a small portion of the content may be overflowed out of the header tank 9 to discharge solids. The waste solids may also be removed by manually draining from the header tank 9 or through the operation of a high solids capable valve.

The embodiment shown in FIG. 1 uses a gas chamber 10 to store gas that is used to clean the membranes 8 and a header tank 9 that stores feed water to allow gravity filtration. Variations of this arrangement can be realised based on the invention. For example, the gas chamber 10 can be designed as an annulus surrounding the membrane modules 6 to reduce the vertical height of the system.

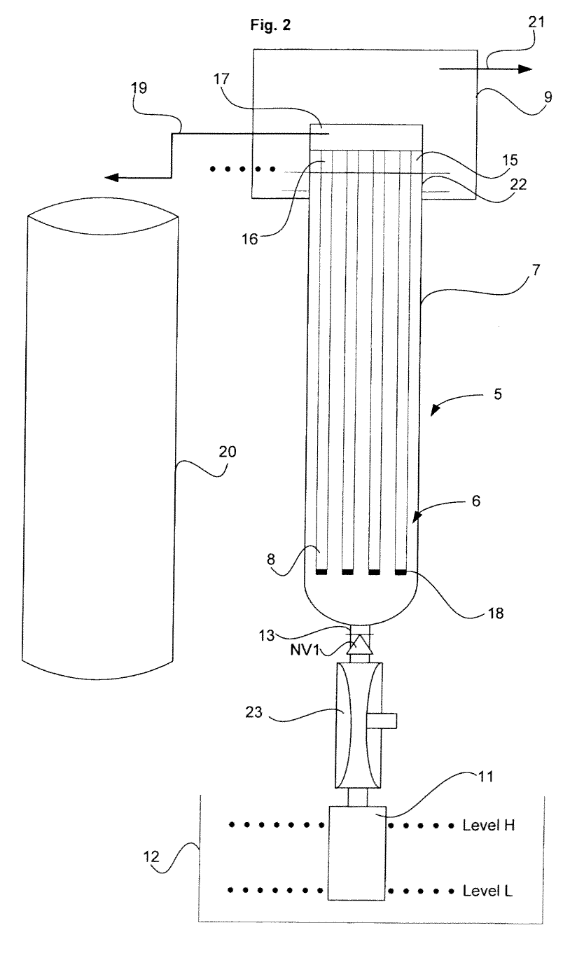

FIG. 2 shows another preferred embodiment of the invention. In this embodiment, the gas chamber 10 and the non-return valve NV2 of the embodiment of FIG. 1 are replaced with a venturi 23 or the like. The venturi 23 may be any suitable device for providing a gas/liquid mixture. As shown, the venturi 23 is positioned in the feed line between the pump 11 and the non-return valve NV1.

When the pump is in operation, the feed water sucks gas in through the venturi 23 to form a two-phase gas/liquid flow which scours the membranes. The feed water within the mixture is delivered through the module vent port 22 to the header tank 9 and the gas released after scouring the membranes 8.

The remainder of this embodiment's operation is similar to that of the first embodiment.

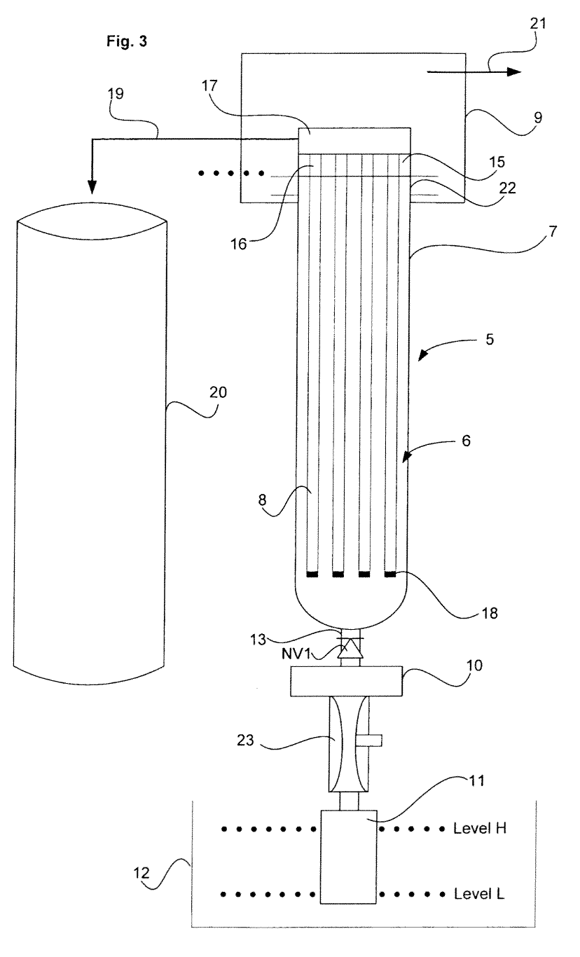

A third embodiment of the invention is shown in FIG. 3. Again, the overall operation is similar to that of the first and second embodiments. To enhance the membrane cleaning efficacy via gas scouring, a venturi 23 may be connected to the gas chamber 10. This configuration overcomes insufficient gas volume (where a large gas reservoir is not feasible) required for an efficient scouring of the membrane in the first embodiment, while allowing the gas bubbles entrained in the feed water through the venturi 23 to partially coalesce and form optimal bubble sizes that most effectively scour the membranes 8.

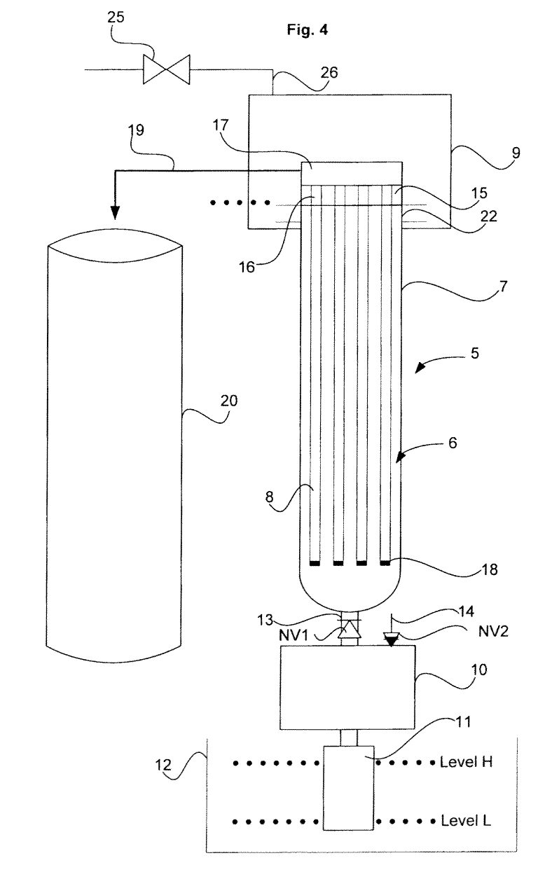

A fourth embodiment of the invention is shown in FIG. 4. The overall operation of this embodiment is similar to the earlier embodiments described above and the concept used may be applied to any of these embodiments.

In this embodiment the header tank 9 is essentially sealed and provided with a pressure control valve 25 connected to the header tank 9 via gas line 26. The liquid level within the header tank 9 can be controlled to a predetermined level by a float control valve under the control of a system controller.

In use, with pump 11 in operation, gas and air are pumped sequentially into the header tank 9 through module vent port 22. As the header tank 9 is sealed, gas pressure within the header tank 9 builds up to a predetermined level determined by the pressure control valve 25. Once the predetermined gas pressure is reached any excess gas is captured and returned to the system as process gas supply via gas line 26. The gas pressure within header tank 9 assists with producing the transmembrane pressure required for filtration.

The systems described above can be applied to direct filtration of water and wastewater, or can be integrated into a hybrid system such as with biological treatment or flocculation systems. When the system is integrated with a biological treatment process, the membrane also behaves like a fixed bio-film and may achieve a certain level of biological activity—oxidising organic substances during the gas scouring stage and promoting denitrification during the non-gas scouring period.

The membrane arrangements shown in the embodiments use outside-in filtration mode, however, it will be appreciated the invention is equally applicable to an inside-out filtration mode where the feed liquid and the gas bubble scour pass through lumens of the membranes. Flat-sheet membrane modules and the like may also be used in the system as the membrane filtration unit.

It will be appreciated that further embodiments and exemplifications of the invention are possible without departing from the spirit or scope of the invention described.

1. A membrane filtration system including:
a feed containing vessel;
a membrane module including one or more hollow permeable membranes for filtering feed liquid, located in said feed containing vessel;
means for applying a pressure differential across walls of said membrane to induce filtration therethrough;
a feed liquid reservoir in fluid communication with said membrane module to supply feed liquid thereto;
to a source of feed liquid;
a source of gas;
means for selectively producing a flow of gas from said gas source and feed liquid from said feed liquid source through said membrane module and into said feed liquid reservoir,
said flow of gas producing gas bubbles within said feed liquid to clean said membranes.

2. A membrane filtration system according to claim 1, wherein the means for producing a flow of gas and feed liquid includes a pump.

3. A membrane filtration system according to claim 2, wherein the gas source comprises a gas-containing reservoir.

4. A membrane filtration system according to claim 3, wherein the pump is provided between the source of feed liquid and the gas-containing reservoir and in fluid communication therewith.

5. A membrane filtration system according to claim 1, wherein the gas-containing reservoir is fluidly connected to said feed-containing vessel.

6. A membrane filtration system according to claim 1 wherein a non-return valve is provided between the gas-containing reservoir and the feed containing vessel to allow fluid flow from the gas-containing reservoir to the feed containing vessel.

7. A membrane filtration system according to claim 1, wherein the pump is selectively operable in dependence on the level of feed liquid in the source of feed liquid.

8. A membrane filtration system according to claim 7, wherein said source of feed liquid comprises a feed liquid supply tank and a first and a second level detection means are provided in said tank, said second level detection means detecting a second level of feed liquid in said tank higher than a first level detected by said first level detection means, and wherein said pump is responsive to detection of said second level of feed liquid to operate and to detection of said first level of feed liquid to cease operation.

9. A membrane filtration system according to claim 8, wherein the first and/or second level detection means are integrated with said pump.

10. A membrane filtration system according to claim 7, further including a timer means operable to activate said pump for a predetermined period and wherein said source of feed liquid comprises a feed liquid supply tank and a level detection means is provided in said tank, said level detection means detecting a predetermined level of feed liquid in said tank and wherein said timer means is responsive to detection of said predetermined level of feed liquid to activate said pump for said predetermined period.

11. A membrane filtration system according to claim 10, wherein the level detection means is integrated with said pump.

12. A membrane filtration system according to claim 1, wherein the means for providing a pressure differential across the membrane walls includes locating the feed liquid reservoir above the level of said membrane module such that a static head pressure is applied to said membranes inducing filtration therethrough.

13. A membrane filtration system according to claim 1, wherein the means for producing the pressure differential across the membrane walls is produced or augmented by a further pump applying pressure to the feed side of the membranes or suction to the filtrate side of the membranes.

14. A membrane filtration system according to claim 13, wherein the further pump is the same pump used to produce a flow of gas and feed liquid.

15. A membrane filtration system according to claim 12, wherein a pressure vessel with an air reservoir above the feed liquid is used to provide a higher driving head pressure.

16. A method of filtering filtrate from a multi-component feed liquid including the steps of:
providing a source of said feed liquid;
providing a source of gas;
flowing gas from said source of gas through a membrane filtration module, including one or more hollow permeable membranes, into a feed liquid reservoir located above said membrane filtration module to produce gas bubbles within and/or around the membranes to remove accumulated solids therefrom;
flowing feed liquid from the source of feed liquid past the membranes within said module to sweep said removed solid from the membrane filtration module; and
producing filtration of feed liquid through a wall of said membranes by application of static or driven head pressure from feed liquid held in said feed liquid reservoir.

17. A method according to claim 16, wherein the flow of feed liquid and gas is selectively controlled in response to a level of feed liquid at the source of feed liquid.
